(19) United States
(12) Patent Application Publication
(10) Pub. No.: US 2014/0260979 A1
(43) Pub. Date: Sep. 18, 2014

(54) PROCESSES FOR THE REJUVENATION OF AN AMINE ACID GAS ABSORBENT USED IN AN ACID GAS RECOVERY UNIT

(71) Applicant: CANSOLV TECHNOLOGIES INC., Montreal (CA)

(72) Inventor: Mélina Infantino, Montreal (CA)

(73) Assignee: CANSOLV TECHNOLOGIES INC., Montreal (CA)

(21) Appl. No.: 13/830,256

(22) Filed: Mar. 14, 2013

(51) Int. Cl. B01D 19/00

(52) U.S. Cl. CPC B01D 19/0005
USPC 95/179; 95/178

(57) ABSTRACT

A process for the recovery of an amine acid gas absorbent used in an acid gas recovery unit, comprising obtaining an amine-containing waste stream from a heat stable salt (HSS) removal unit wherein a HSS containing amine acid gas absorbent stream is contacted with a base and subjected to a first phase separation step whereby a light regenerated amine absorbent stream and the amine-containing waste stream are produced; contacting the amine-containing waste stream with an organic solvent and obtaining an amine rich organic solvent stream and an amine reduced waste stream; and contacting the amine rich organic solvent stream with an acid and obtaining a protonated amine stream and an amine reduced organic solvent stream.

### FIELD

The specification relates to processes for the rejuvenation of an amine acid gas absorbent used in an acid gas recovery unit. Particularly, the specification relates to a process to remove contaminants, such as heat stable salts (HSS), alkali metals and transition metals from an absorbent used in an acid gas capture process.

### INTRODUCTION

The following is not an admission that anything discussed below is prior art or part of the common general knowledge of persons skilled in the art.

The separation of acid gases such as sulfur dioxide (SO₂) or carbon dioxide (CO₂) from gas streams such as waste gas streams, for example flue gas or hydrocarbon-containing streams by means of absorption into aqueous amine solvents is known. Many of these processes, which may be referred to as amine treater processes, are described in “Gas Purification”, 5th Edition, Arthur L. Kohl and Richard B. Nielsen, Eds., Gulf Publishing Company, Houston, Tex.

Amine treater processes use a regenerable amine solvent whereby the acid gas is captured or absorbed into the solvent at one temperature and the acid gas is desorbed or stripped from the solvent, generally at a higher temperature.

The amine solvent for removing a given acid gas component from a feed stream may be chosen so that the acid gas can be removed from the solvent by steam stripping. If steam stripping is utilized, then in order to separate the acid gas from the solvent, the acid gas must be volatile while in solution. Preferably, the acid ionization constant of the conjugate acid of the amine (the pKa) has a value no more than about 3 or 4 units higher than the pKa of the acid gas. If this difference in pKa is larger than about 3 or 4 units, then the salt formed between the amine and the acid is too stable to be practically dissociated by steam stripping.

In commercial operation, alkali metal cations that are a stronger base than the amine may enter the solvent either through intentional addition or unintentional means such as carryover in a mist. Once in solution, these alkali metal cations may form acids. Accordingly, an acid gas capture process may experience ingress and/or generation in situ of acids that are stronger than the acids for which the removal process is designed. The cations from these stronger acids may remove anions from the amine and form salts with the amine solvent which are not regenerable with steam and are thus termed heat stable amine salts (HSAS), or just heat stable salts.

If the heat stable amine salts are allowed to accumulate, they will eventually neutralize a high enough percentage of the amine of the solvent so that the amine can no longer react with and remove the acid gas component as intended. Accumulation of sodium salts can eventually reach their solubility limit, causing undesirable precipitation of solids in the process.

Further, transition metals such as iron, chromium, nickel and vanadium can enter the solvent in ionic form either through ash carryover or from stainless steel corrosion. For example, the transition metals may be present in the form of sulfates such as iron (II) sulfate (FeSO₄). Accumulation of transition metal ions can, for example catalyze solvent degradation.

Various means for removal of heat stable salts from amine gas treating solutions are known. These include distillation of the free amine away from the salt at either atmospheric or subatmospheric pressure (see, for example “Gas Purification”, p. 255 ff), electrodialysis (see, for example U.S. Pat. No. 5,292,407) and ion exchange (see, for example U.S. Pat. No. 4,122,149; U.S. Pat. No. 4,113,849; U.S. Pat. No. 4,970,344; U.S. Pat. No. 5,045,291; U.S. Pat. No. 5,292,407; U.S. Pat. No. 5,368,818; U.S. Pat. No. 5,788,864 and U.S. Pat. No. 6,245,128). Distillation is, for example very energy consuming, and both electrodialysis and ion exchange technologies, for example generate significant amounts of liquid wastes and result in the loss of process amine.

PCT Publication No. WO 2011/113897 discloses the removal of HSS by phase separation. The amine absorbent is mixed with a sodium hydroxide solution in a tank. Once neutralized, the anion of the HSS has been converted to a sodium salt and the amine to a free base. The aqueous solutions of amine and inorganic salt are allowed to separate into two distinctive phase solutions. The now regenerated amine absorbent solution, which is low in HSS, is sent back to the acid gas absorption process. While consuming less water and generating less waste than regular electrodialysis and ion-exchange, this process leads to significant amine losses, since the waste stream, which is an aqueous solution virtually saturated with salts, still contains a significant concentration of amine.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In accordance with the present disclosure, a process for the rejuvenation of an acid gas absorbent is disclosed. The acid gas absorbent stream may be obtained from an acid gas recovery unit. Therefore, in accordance with this process, an acid gas absorbent may be regenerated and recycled for use in an acid gas recovery unit.

An acid gas recovery unit may operate as follows. The acid gas recovery unit preferably includes an absorption unit and a stripping unit, which are operated as parts of a cyclic process. Accordingly, the absorbent is loaded with acid gas in the absorption unit and at least some of the acid gas is removed from the absorbent in the stripping unit. In this manner, the absorbent is continually cycled through the process. From time to time, fresh absorbent may be added to replace absorbent that is lost during operation of the process.

For example, in the absorption unit, a feed gas (e.g., a waste gas) containing for example sulfur dioxide (SO₂) and optionally one or more of carbon dioxide (CO₂) and nitrogen oxides (NOₓ, wherein x is 1 or 2), is contacted with an absorbent in, e.g., an absorption column. As the feed gas passes through the column, at least some of the sulfur dioxide and optionally, other acid gases such as carbon dioxide and/or nitrogen oxides, are absorbed by an amine absorbent producing an absorbent stream elevated in acid gas content, which may be referred to as a spent or rich absorbent stream.

For example, in the stripping unit, the spent absorbent stream is treated to remove at least some of the sulfur dioxide and, optionally, other acid gases such as carbon dioxide and/or nitrogen oxides that have been absorbed by the absorbent. The absorbent is preferably regenerated using steam, such as by passing the spent absorbent stream through a steam stripper, wherein through the use of steam, the acid gas dissociates from the amine solvent.

Acids, which are stronger than that which can be dissociated from the absorbent using steam stripping, enter the acid gas recovery unit. Such acids remain in the absorbent in the form of the heat stable amine salts.

At least some of the amine absorbent stream comprising at least one heat stable salt, e.g., a bleed stream, is withdrawn from the acid gas recovery unit, preferably subsequent to the steam stripping of the absorbent but prior to the reuse of the absorbent in the absorption step, and is then directed to a phase separation unit such as is disclosed in PCT Publication No. WO 2011/113897, the disclosure of which is incorporated herein in its entirety. The phase separation unit preferably comprises a tank in which the amine molecule is separated from the HSS by neutralizing the HSS with a stronger base than the amine, such as a solution of sodium hydroxide (NaOH).

The anion of the HSS is converted to a sodium salt and the amine to a free base, thereby regenerating the amine absorbent. The aqueous solutions of amine and inorganic salt may be separated into two distinctive phase solutions, namely a regenerated amine absorbent stream and a waste stream. The regenerated amine absorbent stream, which is low in HSS, may be sent back to the acid gas recovery unit.

The present disclosure provides a process for the recovery of amine absorbent from the waste stream using a solvent, such as via an extraction step, and liquid/liquid separation. It has been determined that the waste stream contains a significant amount of amine absorbent (e.g., from about 2 to about 10 wt. % based on the total weight of the waste stream). An advantage of the process is that the process may not consume water and may not dilute the amine absorbent that is recovered by the process. This recovered amine may then be recycled to the acid gas recovery unit. Another advantage is that the process may significantly reduce the generation of liquid waste and the amine losses, compared to known reclaiming technologies, such as ion exchange or electrodialysis.

In accordance with an embodiment of the process, the process comprises obtaining an amine-containing waste stream from a heat stable salt (HSS) removal unit wherein a HSS containing amine acid gas absorbent stream is contacted with a base and subjected to a first phase separation step whereby a light regenerated amine absorbent stream and the amine-containing waste stream are produced; contacting the amine-containing waste stream with an organic solvent and obtaining an amine rich organic solvent stream and an amine reduced waste stream; and contacting the amine rich organic solvent stream with an acid and obtaining a protonated amine stream and an amine reduced organic solvent stream. In some embodiments, the HSS containing acid gas absorbent may be obtained from an acid gas recovery unit and some or all of the protonated amine stream is recycled to the acid gas recovery unit as an acid gas absorbent.

In some embodiments, the base may comprise an alkali metal hydroxide. In some embodiments, the alkali metal hydroxide may be provided in an aqueous solution having a concentration of alkali metal hydroxide of at least about 20 wt. %. In some embodiments, the alkali metal hydroxide may be provided in an aqueous solution having a concentration of alkali metal hydroxide from about 20 wt. % to about 50 wt. %. In some embodiments, the alkali metal hydroxide may be provided in an aqueous solution having a concentration of alkali metal hydroxide from about 40 wt. % to about 50 wt. %. In some embodiments, the alkali metal hydroxide may be sodium hydroxide.

In some embodiments, the first phase separation step may be operated at a temperature from about 20° C. to about 60° C. In some embodiments, the first phase separation step may be operated at a temperature from about 20° C. to about 35° C. In some embodiments, the first phase separation step may be operated at a temperature from about 25° C. to about 30° C.

In some embodiments, the amine acid gas absorbent may comprise sulfate at an SO₄²⁻ concentration of from about 5 wt. % to about 25 wt. %. In some embodiments, the amine acid gas absorbent may comprise a sulfate at an SO₄²⁻ concentration of from about 15 wt. % to about 20 wt. %.

In some embodiments, the amine acid gas absorbent may have a concentration of amine greater than about 25 wt. %. In some embodiments, the amine acid gas absorbent may have a concentration of amine from about 20 wt. to about 35 wt. %. In some embodiments, the amine acid gas absorbent may have a concentration of amine from about 25 wt. % to about 30 wt. %.

In some embodiments, the organic solvent may comprise or consist essentially of a C₄-C₁₂ alcohol. In some embodiments, the organic solvent may comprise or consist essentially of a C₆-C₇ alcohol. In some embodiments, the C₄-C₁₂ alcohol may be selected from n-butanol, n-pentanol, n-hexanol and n-heptanol. In some embodiments, the organic solvent may comprise or consist essentially of a C₄-C₁₂ alcohol water solution comprising at least about 90 wt. % C₄-C₁₂ alcohol.

In some embodiments, the step of contacting the amine-containing waste stream with an organic solvent and obtaining an amine rich organic solvent stream and an amine reduced waste stream may comprise an extraction step. In some embodiments, the extraction step may be operated at a temperature from about 10° C. to about 100° C. In some embodiments, the extraction step may be operated at a temperature from about 40° C. to about 100° C. In some embodiments, the extraction step may be operated at a temperature from about 80° C. to about 90° C.

In some embodiments, the protonated amine stream may be separated from the amine reduced organic solvent stream by a second phase separation step. In some embodiments, the second phase separation step may be operated at a pH of from about 0 to about 7. In some embodiments, the second phase separation step may be operated at a pH of from about 5 to about 6. In some embodiments, the amine acid gas absorbent may comprise an amine having a salted nitrogen with a pKa and the second phase separation step may be operated at a pH of at least about 2 pH units below the pKa of the salted nitrogen. In some embodiments, the second phase separation step may be operated at a pH of about 2 to about 4 pH units below the pKa of the salted nitrogen. In some embodiments, the second phase separation step may be operated at a pH of about 2 to about 3 pH units below the pKa of the salted nitrogen.

In some embodiments, the amine may be a diamine. In some embodiments, the diamine may be N-(2-hydroxyethyl)piperazine, N,N′-bis(hydroxyethyl)piperazine, N,N′-bis(hydroxyethyl)2-piperazone or a combination thereof. In some embodiments, the amine may be a composition comprising N,N′-bis(hydroxyethyl)piperazine and N-(2-hydroxyethyl)piperazine in a ratio by weight of about 5:1 to about 20:1.

In some embodiments, the amine acid gas absorbent may further comprise a physical solvent such as Selexol™. In some embodiments, the amine acid gas absorbent may comprise from about 1 wt. % to about 25 wt. % Selexol.

In some embodiments, the acid may comprise a mineral acid, an organic acid, an acid gas or mixtures thereof. In some embodiments, the mineral acid may be an aqueous solution comprising from about 50 wt. % to about 98 wt. % sulfuric acid. In some embodiments, the mineral acid may be an aqueous solution comprising from about 95 wt. % to about 98 wt. % sulfuric acid. In some embodiments, the acid gas may comprise SO₂ and/or CO₂.

In some embodiments, the HSS containing acid gas absorbent is obtained from an acid gas recovery unit and some or all of the protonated amine stream is recycled to the HSS containing amine acid gas absorbent stream of the step of obtaining an amine-containing waste stream from a HSS removal unit.

### DRAWINGS

The drawings included herewith are for illustrating an example of the process of the present specification and are not intended to limit the scope of what is taught in any way.

In the following description, reference will be made to the accompanying drawings, in which:

FIG. 1 is a schematic diagram of a process according to an embodiment of the present disclosure.

FIG. 2 is a plot showing heat stable salt (HSS) removal efficiency as a function of sulfate concentration in an amine absorbent after treatment with a caustic solution and extraction.

FIG. 3 is a plot showing amine recovery yield as a function of sulfate concentration in an amine absorbent after treatment with a caustic solution and extraction.

### DESCRIPTION OF VARIOUS EXAMPLES

### I. Definitions

Unless otherwise indicated, the definitions and embodiments described in this and other sections are intended to be applicable to all embodiments and aspects of the specification herein described for which they are suitable as would be understood by a person skilled in the art.

As used in the present specification, the singular forms “a”, “an” and “the” include plural references unless the content clearly dictates otherwise. For example, embodiments including “an amine” should be understood to present certain aspects with one amine, or two or more additional amines.

In embodiments comprising an “additional” or “second” component, such as an additional or second amine, the second component as used herein is different from the other components or first component. A “third” component is different from the other, first, and second components, and further enumerated or “additional” components are similarly different.

In understanding the scope of the present specification, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The term “immiscible” as used herein when referring to two liquid phases means that the two liquid phases cannot be mixed to form a solution having a single phase under the conditions used such as the relative proportions of the two liquid phases and/or the temperature, etc. Two immiscible liquid phases will, for example separate into two liquid phases after mixing. Each of these two liquid phases may, for example contain small amounts of the other liquid phase.

The term “organic solvent” as used herein refers to a liquid that is immiscible with water, is capable of solubilizing an amine (an amine that is used to absorb an acid gas) from an amine acid gas absorbent (e.g., a solution comprising the amine) and that comprises, consists essentially of, or consists of at least one organic compound. For example, the organic solvent may consist of a single organic compound, and optionally small amounts (for example, less than about 15%, about 10%, about 5%, about 4%, about 3%, about 2%, about 1%, about 0.5% or about 0.1%) of one or more other compounds and/or salts that are soluble in the organic compound. For example, the organic solvent may consist of a mixture of two or more organic compounds and optionally, small amounts (for example, less than about 15%, about 10%, about 5%, about 4%, about 3%, about 2%, about 1%, about 0.5% or about 0.1%) of one or more other compounds and/or salts that are soluble in the mixture. The selection of a suitable organic solvent for the processes of the present disclosure will depend, for example on the conditions used in the processes such as temperature and/or pressure as well as the solubility of a particular amine from an amine acid gas absorbent in the organic solvent but such a selection can be made by a person skilled in the art. In some embodiments, the organic solvent may comprise, consist essentially of, or consist of at least one alcohol.

The term “alcohol” as used herein refers to an organic compound comprising at least one hydroxyl (—OH) moiety that is a liquid under the conditions used (e.g. temperature and pressure), is immiscible with water and is capable of solubilizing an amine (an amine that is used to absorb an acid gas) from an amine acid gas absorbent (e.g., a solution comprising the amine). The choice of a suitable alcohol for a particular amine can be made by a person skilled in the art. The term C₄-C₁₂ alcohol means an alcohol having 4, 5, 6, 7, 8, 9, 10, 11 or 12 carbon atoms and at least one, for example 1-4, 1-3, 1-2 or 1 hydroxyl moiety.

The term “alkyl” as used herein means straight or branched chain, saturated alkyl groups. The term C₄-C₁₂ alkyl means an alkyl group having 4, 5, 6, 7, 8, 9, 10, 11 or 12 carbon atoms.

The term “alkenyl” as used herein means straight or branched chain, unsaturated alkenyl groups. The term C₄₋₁₂ alkenyl means an alkenyl group having 4, 5, 6, 7, 8, 9, 10, 11 or 12 carbon atoms and at least one double bond. The term C₄₋₁₂ alkenyl-OH means an alcohol having 4, 5, 6, 7, 8, 9, 10, 11 or 12 carbon atoms, at least one double bond and a hydroxyl moiety, wherein the hydroxyl moiety is attached to a carbon atom other than a carbon atom in a double bond.

The term “alkynyl” as used herein means straight or branched chain, unsaturated alkynyl groups. The term C₄₋₁₂ alkynyl means an alkynyl group having 4, 5, 6, 7, 8, 9, 10, 11 or 12 carbon atoms and at least one triple bond. The term C₄₋₁₂alkylnyl-OH means an alcohol having 4, 5, 6, 7, 8, 9, 10, 11 or 12 carbon atoms, at least one triple bond and a hydroxyl moiety.

The term “acid gas” as used herein refers to a gas comprising at least one gas that may form an acidic compound when contacted with water. In some embodiments, the acid gas comprises at least one of sulfur dioxide (SO₂), carbon dioxide (CO₂), hydrogen sulfide (H₂S) and nitrogen oxides (NOₓ, wherein x is 1 or 2).

The term “physical solvent” as used herein refers to a solvent that can be used in an acid gas recovery unit to absorb at least one acid gas without a chemical reaction occurring between the acid gas and the solvent. In some embodiments, the physical solvent can be Selexol™ or a similar mixture of relatively low molecular weight polyethylene glycol dimethyl ethers, which can be produced, for example from an etherification reaction using polyethylene glycol. For example, Selexol comprises a mixture of compounds having the chemical formula CH₃O(C₂H₄O)ₙCH₃ wherein n is an integer from 2 to 9. In other embodiments, the physical solvent can be a glycol such as ethylene glycol (EG), diethylene glycol (DEG), triethylene glycol (TEG), a polyethylene glycol (PEG) or mixtures thereof. The selection of a suitable physical solvent for a particular process can be made by a person skilled in the art.

The term “N-(2-hydroxyethyl)piperazine refers to a diamine having the following structure:

[chemical structure]

The term “N,N′-bis(hydroxyethyl)piperazine refers to a diamine having the following structure:

[chemical structure]

The term N,N′-bis(hydroxyethyl)2-piperazone refers to a diamine having the following structure:

[chemical structure]

### II. Processes

Various apparatuses or methods will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention.

An exemplary process flow diagram is shown in FIG. 1. The exemplified process is a process for the recovery of an amine used in an acid gas recovery unit. Referring to FIG. 1, in the exemplified process, a heat stable salt (HSS) containing amine acid gas absorbent stream 1 may be obtained from an acid gas recovery unit (e.g., it may be a bleed stream). Stream 1 is contacted with a base provided, e.g., via stream 2 and subjected to a first phase separation step whereby a light regenerated amine absorbent stream 3 and an amine-containing waste stream 4 are produced. The HSS containing amine acid gas absorbent stream 1 can be contacted with the base 2 and separated therefrom by any means known in the mixing art.

For example, settling tank 5 may be partially filled with the HSS containing amine acid gas absorbent from the HSS containing amine acid gas absorbent stream 1, and the base may be added to or upstream of the settling tank 5. A mixing means 6 such as a static mixer may be used to efficiently mix the base with the HSS containing amine acid gas absorbent. Accordingly, as stream 1 flows to tank 5, it is mixed with stream 2 as it passes through static mixer 6. In other embodiments, mixing means 6 comprises a recirculation pump, a stirrer in tank 5, or the like.

Cooling can optionally be provided to the contents of settling tank 5 by cooling means 7 (which may be an indirect heat exchanger using a cool waste fluid stream), and may be used, for example to inhibit the contents of settling tank 5 from reaching a temperature that would degrade the amine being produced as a reaction product therein and/or a temperature that would prevent the formation of two immiscible phases. For example, it has been shown that no phase separation occurs in this step at a temperature above about 60° C. If tank 5 contains a stirrer or other agitator, then once the HSS has been at least partially neutralized by the base, mixing may be stopped, and the contents of settling tank 5 allowed to separate into two phases; a light regenerated amine absorbent phase and a heavy waste phase. It will be appreciated that the cooling may be provided upstream of tank 5 and/or by cooling tank 5 itself.

In some embodiments, for example where the mixing means 6 comprises a static mixer and the cooling means 7 comprises a heat exchanger, the stream may optionally be passed through a filter (not shown) subsequent to passing through static mixer 6 and prior to entering cooling means 7. The filter may be used to remove, for example, particulate and/or precipitated transition metal hydroxides before they reach the heat exchanger, as they may cause, for example fouling and/or longer separation times in settling tank 5. The transition metal hydroxides may be produced, for example when an HSS containing amine acid gas absorbent stream 1 comprising a transition metal sulfate such as iron (II) sulfate is contacted with stream 2 due to the increased pH resulting from the addition of base from stream 2 such as an alkali metal hydroxide to stream 1.

For example, the contents of settling tank 5 may be allowed to settle or separate until phase separation is complete or sufficiently complete to permit the resultant streams to be removed. The time needed for separation of this mixture to be complete or sufficiently complete may vary, for example, based on the conditions used such as the particular amine and/or the particular base, the concentrations of the various components in the mixture, the concentration of transition metal ions such as transition metal hydroxides in the mixture, the temperature of the mixture and/or the volume of each phase but can be determined by a person skilled in the art. For example, the time can be about 0.1 hours to about 12 hours. While the process would be expected to work with a settling time of greater than about 12 hours, it will be appreciated that the longer the residence time in the settling tank 5, a larger and more costly settling tank 5 will generally be required for this step. In some embodiments, the time can be about 1.5 hours. It will be appreciated that the two phases may be separated by other means, such as by decantation.

As exemplified in FIG. 1, the light regenerated amine absorbent phase can be, for example, pumped out of the side of settling tank 5 as the light regenerated amine absorbent stream 3. In some embodiments, some or all of the regenerated amine absorbent stream 3 may be recycled back to the acid gas recovery unit. The heavy waste phase, which is an aqueous solution comprising a high concentration of salts and at least a portion of the amine may be, for example, pumped from the bottom of settling tank 5 as the amine-containing waste stream 4. In some embodiments, the heavy waste phase is pumped using a slurry pump. In some embodiments, the interface between the light regenerated amine absorbent phase and the heavy waste phase can be, for example detected with a conductimeter that is located near the bottom of the tank so as to inhibit loss of amine (as a component of the light regenerated amine absorbent phase) when pumping the heavy waste phase from the bottom of the settling tank 5. For example, the pumping of the heavy waste phase as the amine-containing waste stream 4 can be stopped upon reaching a conductivity of about 25 mS/cm to about 50 mS/cm or about 25 mS/cm to about 35 mS/cm or about 35 mS/cm or lower on the conductimeter.

The amine-containing waste stream 4 may comprise from about 2 to about 10 wt. % of amine (based on the total weight of stream 4), from about 2 to about 5 wt. % of amine, or from about 2 to about 3 wt. % of amine. Stream 4 may also comprise from about 15 to about 30 wt. % of salt (based on the total weight of stream 4), from about 20 to about 30 wt. % of salt, or from about 25 to about 30 wt. % of salt with the remainder comprising or consisting essentially of water (e.g., from about 60 to about 83 wt. % of water (based on the total weight of stream 4), from about 65 to about 78 wt. % of water, or from about 67 to about 73 wt. % of water).

The amine-containing waste stream 4 of FIG. 1 may then be contacted with an organic solvent, such as by contacting the waste stream 4 with organic solvent stream 8 to obtain an amine rich organic solvent stream 9 and an amine-reduced waste stream 10. For example, the amine-containing waste stream 4 can be contacted with an organic solvent 8 in an extraction column 11. In other embodiments, the amine-containing waste stream 4 can be contacted with an organic solvent 8 in a tank, and preferably a stirred tank, a static mixer or the like (not shown). It will be appreciated by a person skilled in the art that various mixing apparatus may be used to allow the two streams to contact each other and for amine to transfer from waste stream 4 to the organic solvent 8. The organic solvent is immiscible with the aqueous portion of amine-containing waste stream 4. Accordingly, at least a portion the amine present in the amine-containing waste stream 4 migrates, along with a small amount of water, to the organic solvent while the charged species such as salts and metallic ions remain in the aqueous phase. The heavy aqueous phase can be, for example, pumped out as amine-reduced waste stream 10. The light phase comprising the organic solvent, the amine and the small amount of water can then be, for example pumped out as the amine-rich organic solvent stream 9. As exemplified, a counter current extraction column 11 is utilized. The organic solvent 8 may be introduced into the upper end of extraction column 11 and flows countercurrent through extraction column 11 to the bottom thereof wherein it may exit the column due to gravity. The amine-containing waste stream 4 may flow upwardly through column 11 due, e.g., to the pressure provided, e.g., by a pump in stream 4 upstream of column 11.

Once the amine has been transferred to the organic solvent stream, the amine may be regenerated to a form suitable for introduction to an absorption column of an acid gas recovery unit, such as by contacting the amine with an acid to produce, e.g., a half salted amine. It will be appreciated by a person skilled in the art that various mixing apparatus may be used to allow the amine-rich organic solvent stream 9 and acid stream 12 to contact each other to produce a combined stream, which may then be subjected to a second phase separation step whereby a protonated amine stream 13 and an amine-reduced organic solvent stream are produced.

As exemplified in FIG. 1, the amine-rich organic solvent stream 9 may be contacted with an acid that is in an acid stream 12 (e.g., an aqueous acid stream) to obtain a protonated amine stream 13 and an amine-reduced organic solvent stream. For example, the amine-rich organic solvent from amine-rich organic solvent stream 9 may be contacted with the acid stream 12 using static mixing provided by mixing means 15 and then passing the combined stream to an amine recovery settling tank 14. In other embodiments, mixing means 15 comprises a recirculation pump, a stirrer in tank 14, or the like.

Heating can optionally be provided to the contents of amine recovery settling tank 14 by a heating means 16 (such as an indirect heat exchanger which may utilize a spent or waste fluid stream that is at an elevated temperature). It will be appreciated that heat may be provided upstream of tank 14 or tank 14 may be heated, such as by a heating jacket. Upon contacting the amine-rich organic solvent with the acid stream 12, the amine in the amine-rich organic solvent, in the presence of the water (which may be from the acid stream 12), will become protonated and will migrate from the organic phase to the aqueous stream.

The heavy aqueous phase may then be recovered. For example, it may be pumped out of the amine recovery settling tank 14 as protonated amine stream 13. In some embodiments, some or all of the protonated amine stream 13 may be recycled to the acid gas recovery unit. In other embodiments, some or all of the protonated amine stream 13 may be recycled and combined with the HSS containing amine acid gas absorbent stream 1 so as to again be contacted with the base stream 2. This can, for example, increase the sulfate and/or amine concentration of the HSS containing amine acid gas absorbent stream 1, thereby improving the net sulfate removal and net amine recovery of this step.

The light phase can, for example be pumped out of amine recovery settling tank 14 as an amine reduced organic solvent stream and may be used as part or all of the organic solvent stream 8. As shown in FIG. 1, in some examples, all of the amine reduced solvent stream is recycled as organic solvent 8 used in contacting the amine-containing waste stream 4.

In some embodiments, the temperature and/or the pH is monitored. For example, the temperature and/or the pH of the contents of the settling tank 5 and/or the amine recovery settling tank 14 can be monitored.

In some embodiments, the HSS containing acid gas absorbent stream 1 of FIG. 1 is an amine absorbent stream from an acid gas recovery unit (not shown). For example, the acid gas recovery unit may comprise an absorption unit and a stripping unit which may, for example, be operated as components of a cyclic process. For example, an amine acid gas absorbent may be loaded with acid gas in the absorption unit and at least a portion of the acid gas, for example substantially all of the acid gas, may be removed from the acid gas in the stripping unit so that the amine acid gas absorbent is cycled through the process. Fresh amine acid gas absorbent may be added periodically, for example to replace amine acid gas absorbent that is lost during operation of the acid gas recovery unit. In some embodiments, the fresh amine acid gas absorbent may be obtained from the light regenerated amine absorbent stream 3 of FIG. 1.

In the absorption unit of the acid gas recovery unit described above, a feed gas (for example, a waste gas) comprising at least one acid gas can be contacted with the amine acid gas absorbent in an absorption column. As the feed gas passes through the column, at least a portion of the at least one acid gas, for example substantially all of the at least one acid gas, may be absorbed by the amine acid gas absorbent, producing an amine acid gas absorbent stream elevated in acid gas content. This stream may be referred to, for example as a spent or rich amine acid gas absorbent stream.

In the stripping unit of the acid gas recovery unit described above, the spent amine acid gas absorbent stream may be treated to remove at least a portion of the at least one acid gas, for example substantially all of the at least one acid gas therein which had been absorbed by the amine acid gas absorbent. The amine acid gas absorbent may be regenerated, for example using steam, such as by passing the spent amine acid gas absorbent stream through a steam stripper. The steam stripper may be used, for example to provide conditions that will dissociate the acid gas from the amine in the amine acid gas absorbent.

In some embodiments, the HSS containing amine acid gas absorbent stream 1 of FIG. 1 is a bleed stream from the acid gas recovery unit. For example, the bleed stream can be withdrawn from the acid gas recovery unit subsequent to the steam stripping of the amine acid gas absorbent but prior to recycling of the amine acid gas absorbent back to the absorption unit.

In some embodiments, the amine acid gas absorbent stream 1 may comprise one or more of sulfates (i.e. salts comprising an SO₄²⁻ ion), thiosulfates (i.e. salts comprising an S₂O₃²⁻ ion), sulfites (i.e. salts comprising an SO₂³⁻ ion), chlorides (i.e. salts comprising a Cl⁻ ion), nitrates (i.e. salts comprising an NO₃⁻ ion) and organic acids such as acetic acid (CH₃COOH), formic acid (HCOOH) and glycolic acid (HOCH₂COOH) (and the conjugate bases thereof).

In some embodiments, the amine acid gas absorbent stream 1 may comprise a sulfate at an SO₄²⁻ concentration of from about 5 wt. % to about 25 wt. %. In some embodiments, the amine acid gas absorbent may comprise a sulfate at an SO₄²⁻ concentration of from about 15 wt. % to about 20 wt. %. In some embodiments, the amine acid gas absorbent may comprise a sulfate at an SO₄²⁻ concentration of from about 13 wt. % to about 16 wt. %. In some embodiments, the amine acid gas absorbent stream 1 may have a concentration of amine greater than about 25 wt. %. In some embodiments, the amine acid gas absorbent stream 1 may have a concentration of amine from about 20 wt. % to about 35 wt. %. In some embodiments, the amine acid gas absorbent stream 1 may have a concentration of amine from about 25 wt. % to about 30 wt. %. The weight percent is based on the total weight of stream 1.

In the step of contacting the HSS containing amine acid gas absorbent stream 1 with a base stream 2, at least a portion of the HSS in the HSS containing amine acid gas absorbent stream 1 is neutralized by a base of stream 2 that is a stronger base than the amine that is a conjugate base to the HSS. In some embodiments, the base comprises, consists essentially of, or consists of an alkali metal hydroxide. For example, the alkali metal hydroxide can comprise, consist essentially of, or consist of potassium hydroxide, sodium hydroxide or a mixture thereof. In some embodiments, the alkali metal hydroxide comprises, consists essentially of or consists of sodium hydroxide (NaOH).

It has been shown that the concentration of alkali metal hydroxide, for example NaOH, contacted with the HSS containing amine acid gas absorbent stream 1 may have, for example, an influence on the segregation of the two phases (i.e. the phase which will comprise the light regenerated amine absorbent stream 3 and the phase which will comprise the amine-containing waste stream 4) and/or on the settling time required to achieve good phase separation. Further, it has also been shown that the concentration of alkali metal hydroxide, for example sodium hydroxide, added to the HSS containing amine acid gas absorbent stream 1 can also have an effect on the formation or non-occurrence of precipitate in mixing/settling tank 5.

For example, the alkali metal hydroxide may be provided in an aqueous solution having a concentration of alkali metal hydroxide of at least about 20 wt. % based on the total weight of the solution. For example, the alkali metal hydroxide may be provided in an aqueous solution having a concentration of alkali metal hydroxide from about 20 wt. % to about 50 wt. %. For example, the alkali metal hydroxide may be provided in an aqueous solution having a concentration of alkali metal hydroxide from about 40 wt. % to about 50 wt. %. For example, the alkali metal hydroxide may be provided in an aqueous solution having a concentration of alkali metal hydroxide of about 50 wt. %.

In some embodiments, the pH of the contents in the settling tank 5 may be from about 10.5 to about 11.5. In some embodiments, the pH of the contents in the settling tank 5 may be above about 11.

It has also been shown that the temperature at which the base, for example the alkali metal hydroxide such as NaOH, is contacted with the HSS containing amine acid gas absorbent stream 1 may also have an influence on the first phase separation step. For example, the first phase separation step may be operated at a temperature from about 20° C. to about 60° C. For example, the first phase separation step may be operated at a temperature from about 20° C. to about 35° C. For example, the first phase separation step may be operated at a temperature from about 25° C. to about 30° C.

For example, an aqueous solution having a concentration of alkali metal hydroxide such as sodium hydroxide of about 50 wt. % (based on the weight of the aqueous solution), contacted with an amine acid gas absorbent stream 1 comprising greater than about 15 wt. % sulfate ion (SO₄²⁻) (based on the weight of the amine acid gas absorbent stream) and greater than about 25 wt. % amine (based on the weight of the amine acid gas absorbent stream) at a temperature from about 20° C. to about 30° C. was found to give a good separation and a short settling time in the first phase separation step of a process of the present disclosure.

In some embodiments, the amine-containing waste stream 4 may comprise an alkali metal salt of the anion formerly associated with the HSS, and optionally at least one transition metal hydroxide such as iron (II) hydroxide (Fe(OH)₂). For example, at least one transition metal hydroxide such as iron (II) hydroxide may be produced when an HSS containing acid gas absorbent stream 1 comprising at least one transition metal sulfate such as iron (II) sulfate is contacted with base stream 2. For example, the anion formerly associated with the HSS can be the anion from the neutralization reaction between a strong acid and the amine in the amine acid gas absorbent. For example, the strong acid may comprise at least one of sulfuric acid (H₂SO₄), nitric acid (HNO₃) and hydrochloric acid (HCl). Accordingly, the anion formerly associated with the HSS may comprise at least one of sulfate (SO₄²⁻), nitrate (NO₃⁻) and chloride (Cl⁻). The cation in the alkali metal salt of the anion formerly associated with the HSS can be selected from Na⁺, K⁺ or a mixture thereof.

In the step of contacting the amine-containing waste stream 4 with the organic solvent stream 8 and obtaining an amine rich organic solvent stream 9 and an amine-reduced waste stream 10, it has been shown that the migration of the amine from the amine-containing waste phase to the organic solvent phase and/or the formation of two distinct immiscible phases may depend, for example on conditions such as the pH and/or the temperature. For example, in some embodiments, the step of contacting the amine-containing waste stream 4 with the organic solvent stream 8 and obtaining an amine rich organic solvent stream 9 and an amine-reduced waste stream 10 may comprise an extraction step. For example, the extraction step may be operated at a temperature from about 10° C. to about 100° C. For example, the extraction step may be operated at a temperature from about 40° C. to about 100° C. For example, the extraction step may be operated at a temperature from about 80° C. to about 90° C. For example, the extraction step may be operated at a pH from about 10.5 to about 11.5

In some embodiments, the organic solvent comprises, consists essentially of, or consists of an alcohol. In some embodiments, the alcohol may comprise or consist essentially of a C₄-C₁₂ alcohol. In some embodiments, the organic solvent may comprise an alcohol water solution comprising at least about 90 wt. % alcohol. For example, the organic solvent may comprise an alcohol water solution comprising or consisting essentially of at least about 90 wt. % of a C₄-C₁₂ alcohol. In some embodiments, the C₄-C₁₂ alcohol may be a C₄₋₁₂alkyl-OH, a C₄₋₁₂alkenyl-OH or a C₄₋₁₂alkynyl-OH. For example, the C₄-C₁₂ alcohol may be a C₄₋₁₂alkenyl-OH. For example, the C₄-C₁₂ alcohol may be a C₄₋₁₂alkynyl-OH. For example, the C₄-C₁₂ alcohol may be a C₄₋₁₂alkyl-OH. In some embodiments, the alcohol may be a primary alcohol or a secondary alcohol. For example, the alcohol may be a primary alcohol. In some embodiments, the alcohol may be a linear (i.e. unbranched) alcohol. For example, the C₄-C₁₂ alcohol may be selected from n-butanol, n-pentanol, n-hexanol and n-heptanol. In some embodiments, the alcohol may comprise or consist essentially of a C₆-C₇ alcohol such as n-hexanol or n-heptanol.

The ratio of the weight of organic solvent to the weight of the amine-containing waste in the step of contacting the amine-containing waste stream 4 with the organic solvent stream 8 may be selected, for example, based on the amount of amine in the amine-containing waste stream 4 and also on the type of extraction. For example, where the organic solvent is n-heptanol (density=0.8 g/mL) in a 1-stage extraction, about 6 grams of heptanol may be added for each about 1 gram of amine-containing waste. For example, where the organic solvent is n-heptanol, and a multistage separation device such as an extraction Karr™ or Scheibel™ column is used, greater than about 1 gram n-heptanol may be added for each about 1 gram of amine-containing waste or about 1.5 to about 2 grams of n-heptanol for each about 1 gram of amine-containing waste may be added.

In the step of contacting the amine rich organic solvent stream with an acid 12 and obtaining a protonated amine stream 13 and an amine reduced organic solvent stream, it has been shown that the solubility of the amine in the organic solvent is dependent on conditions such as the pH. For example, below a certain pH the amine may be in a protonated form that is insoluble in the organic phase. For example, in some embodiments, the protonated amine stream 13 may be separated from the amine reduced organic solvent stream by a second phase separation step. For example, the second phase separation step may be operated at a pH of from about 0 to about 7. For example, the second phase separation step may be operated at a pH of from about 5 to about 6. For example, an amount of acid would be added so that the second phase separation step may be operated at a pH of from about 0 to about 7. For example, an amount of acid would be added so that the second phase separation step may be operated at a pH of from about 5 to about 6. Such a volume may be, for example calculated by the skilled person or can be determined with reference, for example to a device monitoring the pH of the amine recovery settling tank 14. It will be appreciated that the pH may be adjusted upstream of tank 14 or in tank 14 itself.

While not wishing to be limited by theory, it is thought that, at a pH of about 2 pH units below the pKa of the amine, the amine (in protonated form) can migrate from the organic phase to the aqueous phase so as to obtain the protonated amine stream 13 and the amine reduced organic solvent stream. Accordingly, in some embodiments, the amine acid gas absorbent may comprise an amine having a salted nitrogen with a pKa and the second phase separation step may be operated at a pH of at least about 2 pH units below the pKa of the salted nitrogen. For example, the second phase separation step may be operated at a pH of about 2 to about 4 pH units below the pKa of the salted nitrogen. For example, the second phase separation step may be operated at a pH of about 2 to about 3 pH units below the pKa of the salted nitrogen.

In some embodiments, the amine may be a diamine. For example, the diamine may comprise, consist essentially of or consist of N-(2-hydroxyethyl)piperazine, N,N′-bis(hydroxyethyl)piperazine, N,N′-bis(hydroxyethyl)2-piperazone or a combination thereof.

In some embodiments, the diamine may be a composition comprising, consisting essentially of or consisting of N-(2-hydroxyethyl)piperazine and N,N′-bis(hydroxyethyl)piperazine. Any ratio of N,N′-bis(hydroxyethyl)piperazine to N-(2-hydroxyethyl)piperazine would be expected to work in the processes of the present disclosure but generally the higher ratio of N,N′-bis(hydroxyethyl)piperazine to N-(2-hydroxyethyl)piperazine is preferred because it would, for example consume less steam per mass of, for example sulfur dioxide (SO₂) stripped. N,N′-bis(hydroxyethyl)piperazine has a lower pKa than N-(2-hydroxyethyl)piperazine therefore SO₂ is easier to strip. In some embodiments of the present disclosure, the ratio by weight of N,N′-bis(hydroxyethyl)piperazine to N-(2-hydroxyethyl)piperazine is from about 1:1 to about 40:1. In some embodiments of the present disclosure, the ratio by weight of N,N′-bis(hydroxyethyl)piperazine to N-(2-hydroxyethyl)piperazine is from about 5:1 to about 20:1. In some embodiments of the present disclosure, the ratio by weight of N,N′-bis(hydroxyethyl)piperazine to N-(2-hydroxyethyl)piperazine is about 9:1.

In some embodiments, the acid may comprise, consist essentially of or consist of a mineral acid, an organic acid, an acid gas or mixtures thereof. For example, the acid may comprise, consist essentially of or consist of a mineral acid. For example, the mineral acid may comprise sulfuric acid (H₂SO₄), phosphoric acid (H₃PO₄), nitric acid (HNO₃) or mixtures thereof. For example, the mineral acid may comprise sulfuric acid. For example, the mineral acid may be an aqueous solution comprising from about 50 wt. % to about 98 wt. % sulfuric acid. For example, the mineral acid may be an aqueous solution comprising from about 95 wt. % to about 98 wt. % sulfuric acid. For example, the acid may comprise, consist essentially of or consist of at least one acid gas. For example, the acid can comprise SO₂ and/or CO₂.

In some embodiments, the amine acid gas absorbent may further comprise a physical solvent. For example, the physical solvent may comprise, consist essentially of or consist of Selexol or a similar mixture of relatively low molecular weight polyethylene glycol dimethyl ethers or the physical solvent may comprise, consist essentially of or consist of a glycol such as ethylene glycol (EG), diethylene glycol (DEG), triethylene glycol (TEG), a polyethylene glycol (PEG) or mixtures thereof. For example, the physical solvent may be Selexol. For example, the amine acid gas absorbent may comprise from about 1 wt. % to about 25 wt. % Selexol. For example, the physical solvent may be a glycol such as ethylene glycol (EG), diethylene glycol (DEG), triethylene glycol (TEG), a polyethylene glycol (PEG) or mixtures thereof.

### EXAMPLES

The following examples outline the results of lab trials done on Cansolv Absorbent DS™ (Cansolv™ absorbent used to scrub sulfur dioxide from gas streams). The Cansolv Absorbent DS had the composition shown in Table 1:

TABLE 1
Composition of Cansolv Absorbent DS

| Species | Cansolv DS Absorbent |
|---|---|
| Water, wt. % | 54 |
| Amine*, wt. % | 27 |
| Sodium, wt % | 1.06 |
| Sulfate, wt % | 12.9 |
| Density, g/mL | 1.18 |

*N,N′-bis(hydroxyethyl)piperazine and N-(2-hydroxyethyl)piperazine in a 9:1 ratio.

### Example 1

### Overall Process

Part #1 Phase Separation (Cansolv Amine Phase Separation; CAPS™)

The 200 mL beaker which was used for this experiment was weighed with the magnetic stir bar used in the experiments. A 100 mL sample of absorbent was placed in the 200 mL beaker, the beaker immersed in a water bath at 35° C., and stirred with a magnetic bar. Once the temperature of the absorbent reached thermal equilibrium with the water bath, a caustic solution (50 wt. % NaOH) was added gradually. The volume of the caustic solution added was carefully measured until the pH of the solution reached 11.2 (about 30 g caustic solution was added). The mixture was allowed to sit for 2 hours. The volume of the 2 phases formed was measured, and sampling was performed. The organic phase was then extracted with a large syringe, leaving only the aqueous phase in the beaker. The mass of the beaker containing the aqueous phase was taken, and the mass taken in the first step described above, subtracted from this value to give the mass of the aqueous phase. The beaker containing the aqueous phase was then placed in the water bath at 35° C.

Part #2 Extraction with Heptanol at 90° C.

For each gram of aqueous phase (calculated above in Part #1) 6 grams of heptanol (density=0.8 g/ml) was added. For example, if 65 grams of aqueous phase were obtained, 390 grams of heptanol would be needed. This amount was calculated in part based on the amine content but the fact that this was a batch experiment (i.e. a 1-stage extraction) was also taken into consideration. In a multistage separation device such as an extraction Karr™ or Scheibel™ column, for example, a ratio of about 1 gram of aqueous phase to about 1.5 to about 2 grams of heptanol would be expected to result in a similar separation efficiency. The mixture was then stirred for 20 minutes at 90° C. The agitation was then stopped, and the mixture allowed to sit for 30 minutes at 90° C. A syringe was used to sample the two phases. Two clean beakers were weighed. The two phases were separated using a large syringe into the two beakers weighed in the previous step. The weight was then obtained for both phases by the following calculation: (mass of beaker+phase added)−mass of clean beaker=mass of phase, and the mass of each phase was noted down.

Part #3 Extraction with Acid

To the organic phase (top phase) from which the mass was determined above in Part #2 0.02 gram of 98 wt. % sulfuric acid for each gram of organic phase was added at 35° C., and the mixture stirred for 20 minutes. The agitation was then stopped, and the mixture allowed to sit for 30 minutes at 35° C. Both phases were separated using a large syringe, and weighed as described above in Part #2.

Results

### First Step—CAPS

The first extraction comprises the Cansolv Amine Phase Separation (CAPS) process. The organic phase is sent back to the main process and the aqueous phase is used for further extraction. Table 2 shows a summary of results from the experiment described in Part #1, above.

TABLE 2
CAPS results at 35° C.

| | Aqueous phase | Organic phase |
|---|---|---|
| Species | (to alcohol extraction) | (to Cansolv process) |
| Water, wt. % | 63.5 | — |
| Amine, wt. % | 2.09 | — |
| Sodium, ppm | 106079 | — |
| Sulfate, ppm | 210845 | — |
| Mass recovered, g | 61.9 | 67.8 |
| % Amine partitioning | 4% | 96% |
| % Sulfate partitioning | 85.5% | 14.5% |

### Second Extraction—Heptanol at 90° C.

The amine recovery at 90° C. is 98.2%. Table 3 shows a summary of results from the experiment described in Part #2, above.

TABLE 3
Alcohol extraction results at 90° C.

| | Aqueous phase | Organic phase |
|---|---|---|
| | (to waste water | (to sulfuric acid |
| Species | treatment) | extraction) |
| Water, wt. % | balance | 4.4 |
| Amine, ppm | 648 | 4540 |
| Sodium, ppm | — | ~0 |
| Sulfate, ppm | — | ~0 |
| Alcohol, ppm | 16 | balance |
| Mass recovered, g | 47.3 | 366.82 |
| % mass Amine partitioning | 1.8% | 98.2% |

Third Extraction—Sulfuric acid

Table 4 shows a summary of results from the experiment described in Part #3, above.

TABLE 4
Sulfuric acid extraction results at 35° C.

| | Aqueous phase | Organic |
|---|---|---|
| Species | (to Cansolv process) | (recycled solvent) |
| Water, wt. % | 44.91 | 3.7 |
| Amine, ppmw | 137000 | 40 |
| Sulfate, ppmw | 306100 | 14510 |
| Alcohol, ppmw | 34 | balance |
| Mass recovered, g | 4.1 | 357 |
| % mass Amine partitioning | 97.5 | 2.5 |

### Overall Performance of CAPS+Alcohol Extraction+Sulfuric Acid Extraction

The overall amine recovery performance can be seen in Table 5, below. It can be seen that the alcohol and sulfuric acid extraction brings the amine losses down by 43 and 2.8 folds when compared to CAPS alone and ion exchange, respectively.

TABLE 5
Overall performance

| | |
|---|---|
| Amine loss, g amine/net kg sulfate removed from Cansolv | 3.6 |
| Absorbent DS using the process of the present study | |
| Amine loss, g amine/net kg sulfate removed from Cansolv | 154 |
| Absorbent DS using CAPS only | |
| Amine loss, g amine/net kg sulfate removed from Cansolv | 10 |
| Absorbent DS using Ion Exchange | |

### Example 2

### Sensitivity Study of HSS Removal and Amine Recovery with Varying Sulfate Content in the Lean Acid Gas Absorbent

Materials and Methods

The 200 mL beaker which was used for this experiment was weighed with the magnetic stir bar used in the experiments. A 100 mL sample of absorbent (25 wt. % Amine, 12 wt. % SO₄²⁻) was placed in the 200 mL beaker, the beaker immersed in a water bath at 35° C., and stirred with a magnetic bar. Once the temperature of the absorbent reached thermal equilibrium with the water bath, a caustic solution (50 wt. % NaOH) was added gradually. The volume of caustic solution added was carefully measured until the pH of the solution reached 11.2. The mixture was then allowed to sit for 2 hours. The volume of the 2 phases formed was measured, and sampling was performed. The organic phase was then extracted with a large syringe, leaving only the aqueous phase in the beaker. The mass of the beaker containing the aqueous phase was taken, and the mass taken in the first step described above, subtracted from this value to give the mass of the aqueous phase. The aqueous phase was sampled and analyzed for sulfate and amine concentrations. The above was repeated at 4 other sulfate concentrations between 13 and 16 wt. %.

Results

FIGS. 2 and 3 show the HSS removal efficiency versus the sulfate concentration and the amine recovery yield versus the sulfate concentration, respectively. As shown in FIGS. 2 and 3, for the range of sulfate concentrations studied, as the concentration of sulfate is increased, the HSS removal efficiency and the amine recovery yield also increase. However, if sulfate concentration is further increased so that the system is in a liquid-liquid-solid equilibrium region instead of a liquid-liquid equilibrium region, crystallization will occur which is not preferred.

All publications, patents and patent applications are herein incorporated by reference in their entirety to the same extent as if each individual publication, patent or patent application was specifically and individually indicated to be incorporated by reference in its entirety. Where a term in the present specification is found to be defined differently in a document incorporated herein by reference, the definition provided herein is to serve as the definition for the term.

1. A process for the recovery of an amine acid gas absorbent used in an acid gas recovery unit comprising:
a) obtaining an amine-containing waste stream from a heat stable salt (HSS) removal unit wherein a HSS containing amine acid gas absorbent stream is contacted with a base and subjected to a first phase separation step whereby a light regenerated amine absorbent stream and the amine-containing waste stream are produced;
b) contacting the amine-containing waste stream with an organic solvent and obtaining an amine rich organic solvent stream and an amine reduced waste stream; and
c) contacting the amine rich organic solvent stream with an acid and obtaining a protonated amine stream and an amine reduced organic solvent stream.

2. The process of claim 1, wherein the HSS containing acid gas absorbent is obtained from an acid gas recovery unit and the protonated amine stream is recycled to the acid gas recovery unit as an acid gas absorbent.

3. The process of claim 1, wherein the base comprises an alkali metal hydroxide.

4. The process of claim 3, wherein the alkali metal hydroxide is provided in an aqueous solution having a concentration of alkali metal hydroxide of at least about 20 wt. %.

5. The process of claim 3, wherein the alkali metal hydroxide is provided in an aqueous solution having a concentration of alkali metal hydroxide from about 20 wt. % to about 50 wt. %.

6. The process of claim 3, wherein the alkali metal hydroxide is provided in an aqueous solution having a concentration of alkali metal hydroxide from about 40 wt. % to about 50 wt. %.

7. The process of claim 3, wherein the alkali metal hydroxide is sodium hydroxide.

8. The process of claim 1, wherein the first phase separation step is operated at a temperature from about 20° C. to about 60° C.

9. The process of claim 1, wherein the first phase separation step is operated at a temperature from about 20° C. to about 35° C.

10. The process of claim 1, wherein the first phase separation step is operated at a temperature from about 25° C. to about 30° C.

11. The process of claim 1, wherein the amine acid gas absorbent comprises sulfate at an SO₄²⁻ concentration of from about 5 wt. % to about 25 wt. %.

12. The process of claim 1, wherein the amine acid gas absorbent comprises a sulfate at an SO₄²⁻ concentration of from about 15 wt. % to about 20 wt. %.

13. The process of claim 1, wherein the amine acid gas absorbent has a concentration of amine greater than about 25 wt. %.

14. The process of claim 1, wherein the amine acid gas absorbent has a concentration of amine from about 20 wt. % to about 35 wt. %.

15. The process of claim 1, wherein the amine acid gas absorbent has a concentration of amine from about 25 wt. % to about 30 wt. %.

16. The process of claim 1, wherein the organic solvent comprises or consists essentially of a C₄-C₁₂ alcohol.

17. The process of claim 1, wherein the organic solvent comprises or consists essentially of a C₆-C₇ alcohol.

18. The process of claim 16, wherein the C₄-C₁₂ alcohol is selected from n-butanol, n-pentanol, n-hexanol and n-heptanol.

19. The process of claim 16, wherein the organic solvent comprises or consists essentially of a C₄-C₁₂ alcohol water solution comprising at least about 90 wt. % C₄-C₁₂ alcohol.

20. The process of claim 1, wherein step (b) comprises an extraction step.

21. The process of claim 20, wherein the extraction step is operated at a temperature from about 10° C. to about 100° C.

22. The process of claim 20, wherein the extraction step is operated at a temperature from about 40° C. to about 100° C.

23. The process of claim 20, wherein the extraction step is operated at a temperature from about 80° C. to about 90° C.

24. The process of claim 1, wherein the protonated amine stream is separated from the amine reduced organic solvent stream by a second phase separation step.

25. The process of claim 24, wherein the second phase separation step is operated at a pH of from about 0 to about 7.

26. The process of claim 24, wherein the second phase separation step is operated at a pH of from about 5 to about 6.

27. The process of claim 25, wherein the amine acid gas absorbent comprises an amine having a salted nitrogen with a pKa and the second phase separation step is operated at a pH of at least about 2 pH units below the pKa of the salted nitrogen.

28. The process of claim 27, wherein the second phase separation step is operated at a pH of about 2 to about 4 pH units below the pKa of the salted nitrogen.

29. The process of claim 27, wherein the second phase separation step is operated at a pH of about 2 to about 3 pH units below the pKa of the salted nitrogen.

30. The process of claim 27, wherein the amine is a diamine.

31. The process of claim 30, wherein the diamine is N-(2-hydroxyethyl)piperazine, N,N′-bis(hydroxyethyl)piperazine, N,N′-bis(hydroxyethyl)2-piperazone or a combination thereof.

32. The process of claim 30, wherein the diamine is a composition comprising N,N′-bis(hydroxyethyl)piperazine and N-(2-hydroxyethyl)piperazine in a ratio by weight of about 5:1 to about 20:1.

33. The process of claim 1, wherein the amine acid gas absorbent further comprises a physical solvent such as Selexol™.

34. The process of claim 33, wherein the amine acid gas absorbent comprises from about 1 wt. % to about 25 wt. % Selexol.

35. The process of claim 1, wherein the acid comprises a mineral acid, an organic acid, an acid gas or mixtures thereof.

36. The process of claim 35, wherein the mineral acid is an aqueous solution comprising from about 50 wt. % to about 98 wt. % sulfuric acid.

37. The process of claim 35, wherein the mineral acid is an aqueous solution comprising from about 95 wt. % to about 98 wt. % sulfuric acid.

38. The process of claim 35, wherein the acid gas comprises SO₂ and/or CO₂.

39. The process of claim 1, wherein the HSS containing acid gas absorbent is obtained from an acid gas recovery unit and at least some of the protonated amine stream is recycled to the HSS containing amine acid gas absorbent stream of step (a).
